(19) United States
(12) Patent Application Publication
(10) Pub. No.: US 2021/0372601 A1
(43) Pub. Date: Dec. 2, 2021

(54) INK LITE MOBILE LIGHT

(71) Applicant: Patrick James Palzkill, Norwell, MA (US)

(72) Inventor: Patrick James Palzkill, Norwell, MA (US)

(21) Appl. No.: 16/974,342

(22) Filed: Dec. 26, 2019

(51) Int. Cl. F21V 21/03; F21V 19/00; F21S 9/02; H05B 47/11; H05B 47/115; F21V 33/00

(52) U.S. Cl. CPC F21V 21/03; F21V 19/0055; F21S 9/02; F21Y 2115/10; H05B 47/115; F21V 33/0008; H05B 47/11

(57) ABSTRACT

Provided is a custom printed, side and/or back lit with a LED lighting system (referred to as INK LITES) that can be used as a hard wired device as well as a battery powered mobile unit. More specifically, our custom printed LED lights (INK LITES) can be used as a wall decoration, desk light, ceiling light, mobile light for a vehicle, or mobile light used in a personal backpack. Custom and licensed images are printed in the removable, translucent acrylic insert, which can easily be exchanged throughout the lifetime of the lighting system. The screw in pegs on the back of the light can be used to support the desk light in a horizontal or vertical position or removed so that the light can be placed on the wall. When used with the motion sensor and battery pack, it's a night light that turns on via motion sensor or thru the light sensor that can be adjusted based on the consumers desired preferences. The light can be powered by a standard plug with direct current, the attached 12 volt battery, or a larger eight hour plus rechargeable battery that fits in the vehicle or backpack.

### FIELD OF THE INVENTION

INK LITE'S field of invention applies to the general field of custom printed, side and back lit, LED lighting that can be used for advertising and promotional bases, depending on the needs and wants of the consumer or business. INK LITES prints on an interchangeable acrylic insert based on the client's desired needs and wants—and makes is usable for wall and ceiling mounts, desk applications, vehicle usage, or mobile backpacks.

### BACKGROUND OF THE INVENTION

INK LITES has experimented with many different types of LED lighting and printing and has come up with numerous ways to illuminate custom printed images with a low cost and high volume output. The energy savings of LED's over that of florescent bulbs allows for battery operation and thus the unshackling of illumination from the power outlet to mobile applications that can be powered by new miniaturized 12 volt batteries. INK LITES obtained licensing rights from IMG and Learfield in 2017 to print college logos for dozens of educational institutions. INK LITES also obtain licensing from Shutterstock in 2017 to print over 250,000,000 different licensed images. We've experimented with several different sizes of shapes of LED general purpose lighting, to include 2′×4′, 2′×2′, 1′×4′ and 8″×12″.

### SUMMARY OF THE INVENTION

INK LITE's invention pertains to custom printed images on side lit general purpose LED lighting. The lighting is powered by direct current plug-ins, hard wired, and battery powered units. The UV-LED curable inks are applied to an acrylic substrate and can be interchanged as the customer sees fit. The INK LITES can be used as a wall hanging, desk light, night light, vehicle light, ceiling light and mobile backpack light.

### BRIEF DESCRIPTION OF DRAWINGS

FIG. 1 Illustrates the front of the light that consists of shatter resistant glass lens which is adhered to the plastic backing with polymercaptan and amine instant-setting epoxy. Image illustrates our 9 inch by 12 inch model.

FIG. 2 Illustrates a blackened boarder in order to prevent bleed thru of the side lit LED lighting encased behind the front glass panel.

FIG. 3 Illustrates side lit 3528 water resistant LED strips 12 VDC IP65 6000-7000K which run lengthwise along the two longest axis.

FIG. 4 Illustrates female receptacle for 12 volt receiver.

FIG. 5 Illustrates stainless steel corner brackets used for wall hanging.

FIG. 6 Illustrates a polycarbonate slotted backing.

FIG. 7 Illustrates a 1½ inch stainless steel flat corner braces.

FIG. 8 Illustrates two 12 volt batteries wired in series.

FIG. 9 Illustrates Interchangeable DC 12V to 24V Mini Pir Motion Sensor switch, occupancy sensor switch, with adjustable controls.

FIG. 10 Illustrates AC Adapter. Input: 100-240V-50/60 Hz 0.4 A Output: 12.0V=1.0 A UL approved to be used when not using battery.

FIG. 11 Illustrates adjustable sliding nuts to receive stand up pegs, for horizontal or vertical viewing.

FIG. 12 Illustrates ⅛^{th} inch opening where custom printed acrylic sheet slides in and out of.

FIG. 13 Illustrates 6 mil dispersion glass and backing and horizontal desk light, or removed for wall mounting or mobile use.

FIG. 16 Illustrates custom printed 2 mil acrylic insert with laser rounded corners.

FIG. 17 Illustrates horizontal view of desk light with pegs inserted.

FIG. 18 Illustrates horizontal view of wall light with pegs removed.

FIG. 19 Illustrates vertical view of wall light with pegs removed.

FIG. 20 Illustrates vertical view of desk light with pegs inserted.

FIG. 21 Illustrates INK LITE mobile application in vehicle window.

FIG. 22 Illustrates Velcro adhesion application.

FIG. 23 Illustrates INK LITE in mobile backpack with image or advertising.

FIG. 24 Illustrates PC 1.3-12F1 Non-spillable sealed rechargeable 12 V battery located inside of backpack.

FIG. 25 Illustrates detachable 12V power cord.

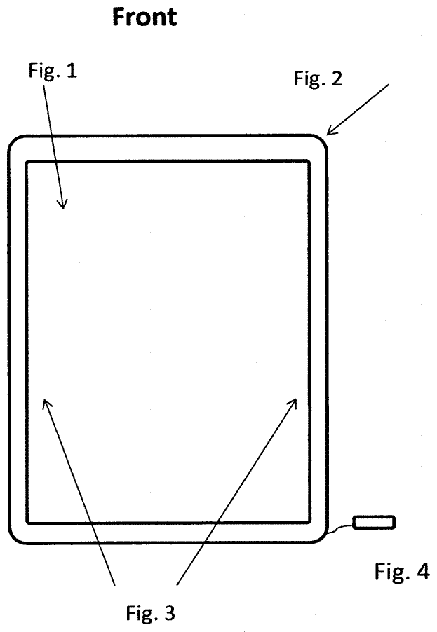

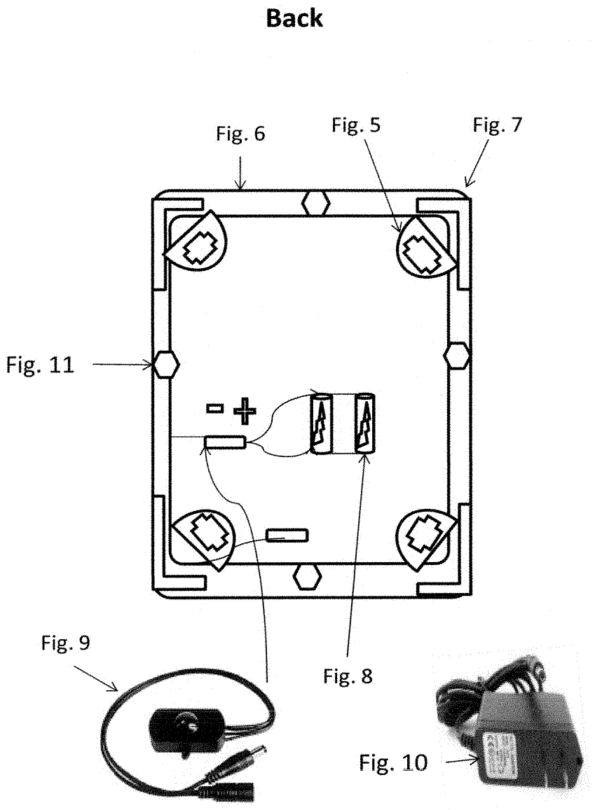

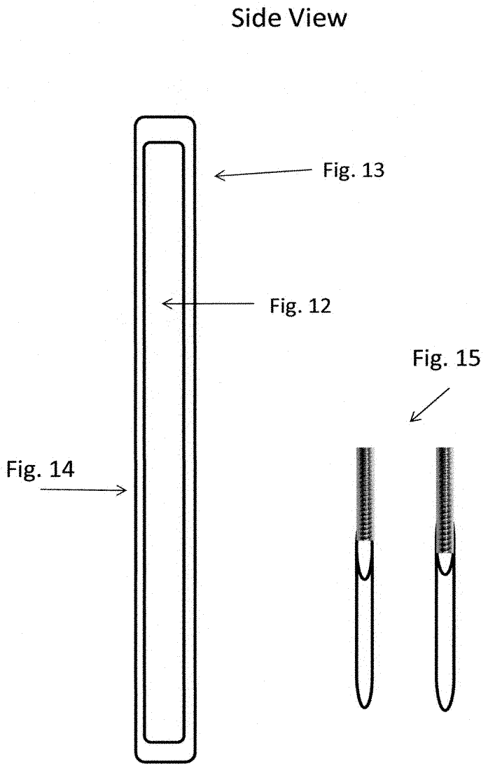

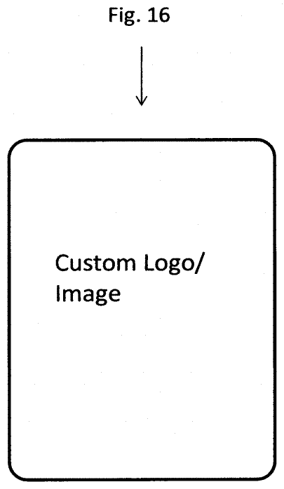

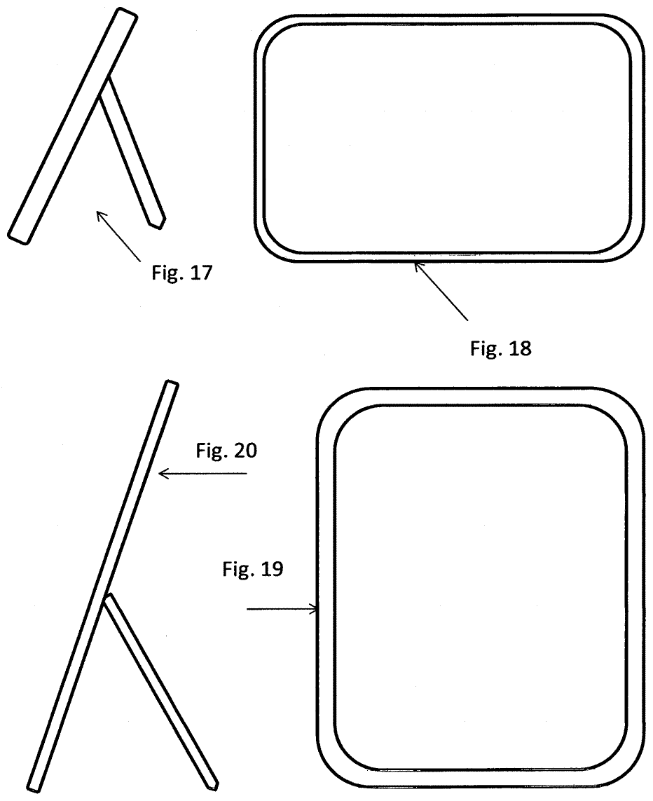

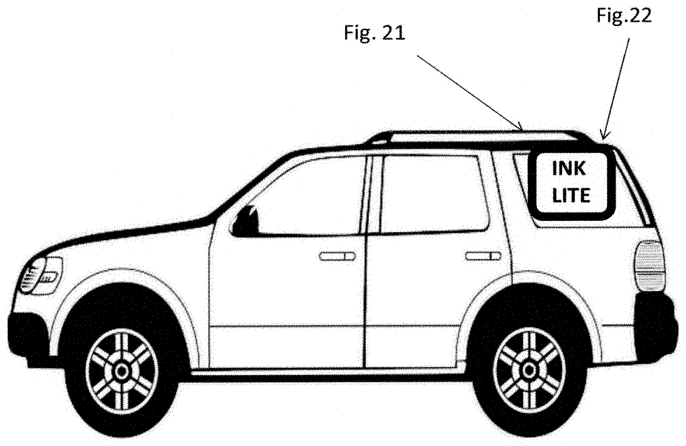

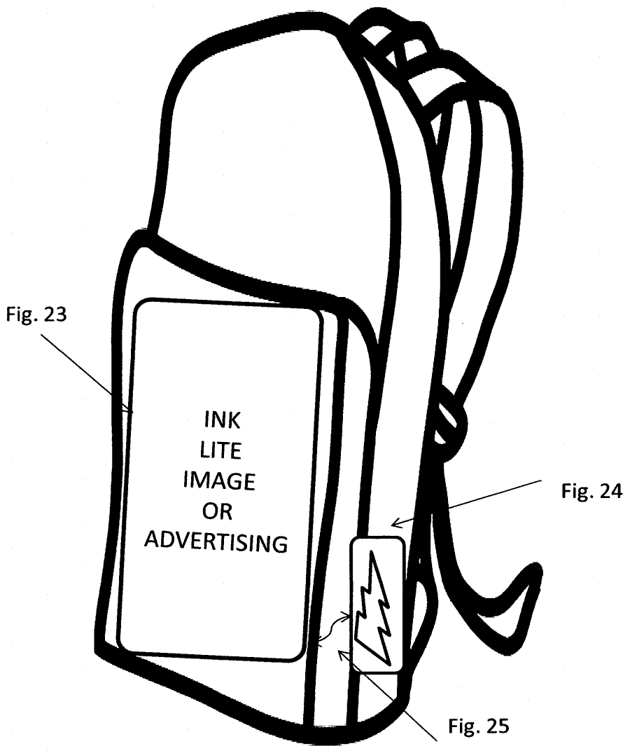

What is claimed is:

1. The Custom Printed LED lighting (referred to as INK LITES) can be used in a number of different ways. Specifically: A.) The Custom Printed LED Lights (INK LITES) mounted on a wall or ceiling either vertically or horizontally via the attached/detachable corner mounting brackets. B.) INK LITES can be used as a desk light, simply by attaching the two four inch stainless steel screw-in pegs, either in an adjustable vertical or horizontal position. C.) INK LITES can be used as a night light, (either battery powered or plugged directly into the standard wall outlet). The night lights can be adjusted so that they come on when the sensor senses darkness or when the sensor senses motion. The light can be adjusted to stay on for two seconds or up a range of a few minutes or permanently on. D.) INK LITES can be used in a vehicle, SUV or mobile home. They can be powered thru the standard plug in, cigarette lighter, the attached 12 volt battery or larger rechargeable battery that lasts over eight hours. E.) INK LITES are mobile and can be used in a backpack. The backpack version can run off the attached 12 volt batteries or attached to a larger rechargeable battery that last more than eight hours.

2. INK LITES currently has over 250,000,000 licensed images thru Shutterstock as well as numerous colleges licensed thru IMG/Learfield. Colleges include but not limited to: Boston University, Iowa State University, Brown University, Purdue University, DePaul University, Assumption College, Wellesley College, Brandeis University, United States Military Academy, Naval Academy, Massachusetts Maritime, Bates College, and many others.

3. INK LITES also prints business logos and non-licensed images as provided by clients as well as INK LITES owned images.

4. INK LITES uses various printing methods to create different affects desired as desired by its' clients. The custom prints are printed on 2 mil thick translucent acrylic that can accept UV-LED curable inks from various digital printers.

5. INK LITES that are printed on acrylic may or may not have a laminate coating that protects the UV-LED curable inks, depending on customer preference.

6. INK LITES generally prints on a 2 MIL acrylic insert that is laser cut to 8.25 inches by 11.75 inches however sizes can vary based on customer requests. The acrylic has a transparency of 90% but can vary based on customer requests.

7. INK LITES are powered by a standard electrical cord or two 12 volt batteries wired in succession. 12 volt interchangeable adapters can be swapped out to offer direct current or battery powered operation.

8. INK LITES offers a motion detector that can be swapped into the apparatus by simply unplugging the battery and plugging the motion sensor into the INK LITE. Delay time on motion sensor can range from 2-280 seconds and is adjustable. Sensor Distance Sensitivity can range from 10 cm to 7 cm and is adjustable. This function enables the consumer to use the motion sensor in different ambient conditions. The sensor will turn the INK LITE on when the room LUX value is lower than the sensor LUX setting value.

9. INK LITES offer a Sensky BS010I DC12Volt Mini Pir Motion Sensor Switch, Occupancy Sensor Switch with Light Sensor. Light sensor is adjustable from 10-300 LUX.

10. INK LITES offers a mobile version that allows for the light to be transported in any vehicle. The INK LITE can be powered by a standard plug in within the car, a standard cigarette lighter (with provided adapter) the attached 12 volt battery or a larger 12 volt rechargeable battery that last eight hours or longer.

11. INK LITES offer a mobile version that can be used in a custom designed backpack. The backpack has a see thru pouch on the back where the INK LITE can be inserted. The INK LITE can then be used in its off position, powered via the attached 12 volt battery, or powered thru a link to a larger 12 volt rechargeable battery held within the backpack, that last eight hours or more.

12. INK LITES offers a manufacturing process where the front of the light is a flat panel transparent shatter resistant glass sheet, that ranges from ⅛^{th″} to ¼″ thickness with laser routed corners and blackened edges to prevent light bleed thru.

13. INK LITES LEDs are side lit into etched glass for uniform diffusion across the lighting surface. Corners are rounded and reinforced with plastic corners to provide sturdiness and allow for ease of assembly.

14. INK LITES four inch adjustable stainless steel pegs are screwed into a ⅛″ diameter hexagonal nut that is adjustable within the plastic frame of the back of the light. This allows for numerous adjustable positions of the light based on the preference of the consumer.
